(19) United States
(12) Patent Application Publication
(10) Pub. No.: US 2025/0182947 A1
(43) Pub. Date: Jun. 5, 2025

(54) ELECTRONIC DEVICE AND FABRICATION METHOD THEREOF

(71) Applicant: INDIAN INSTITUTE OF TECHNOLOGY ROPAR, Punjab (IN)

(72) Inventors: Mahendra SAKARE, Punjab (IN); Mayank Kumar SINGH, Punjab (IN); Upendra CHICHHULA, Punjab (IN); Rajasekhar NAGULAPALLI, Oxford (GB)

(73) Assignee: INDIAN INSTITUTE OF TECHNOLOGY ROPAR, Punjab (IN)

(21) Appl. No.: 18/617,417

(22) Filed: Mar. 26, 2024

(30) Foreign Application Priority Data
Nov. 30, 2023 (IN) 202311081510

(51) Int. Cl. H01F 17/00; H01F 21/12

(52) U.S. Cl. CPC H01F 17/0006; H01F 21/12; H01F 2017/0073; H01F 2021/125

(57) ABSTRACT

The present invention discloses an electronic device having a multi-lobe differential inductor with two terminals fabricated on a P-substrate, The electronic device comprises a broken ring electrically coupled with the ground ring (M5), positioned around a perimeter of the substrate such that the inductor is surrounded by the ground ring and the broken ring. The broken ring defines a plurality of parallelly arranged structures; each structure comprises a plurality of metal segments (M₁-M₄, M₆-M₁₀) parallel to each other and electrically connected to and perpendicular to the ground ring.

### CROSS-REFERENCE TO RELATED APPLICATIONS AND PRIORITY

The present application claims benefit from Indian Patent Application No.: 202311081510 filed on 30 Nov. 2023 entirety of which is hereby incorporated by reference.

### TECHNICAL FIELD

The present subject matter described herein, in general, relates to an electronic device. Particularly, the present subject matter relates to the electronic device containing a compact model of a substrate and an inductor, where the inductor fabricated on the substrate is surrounded by a broken ring and a ground ring, provides improved coupling, designed for wireline applications.

### BACKGROUND OF THE INVENTION

Currently, a persistent challenge arises from the mutual coupling between neighbouring coils, driven by the magnetic flux interlinkage of on-chip inductors. This phenomenon results in undesirable effects, notably strong S21 (S-parameters) and the generation of unwanted spurs when integrated with other circuits utilizing these inductors. There is a need for newly designed inductor architecture or the electronic device to counteract the magnetic flux dispersion outside the inductor to ensure that neighbouring inductors remain unaffected by coupling, substantially reducing S21 and its associated adverse consequences. Conventionally, designers address this issue by resorting to the wide spacing between inductors, thereby mitigating coupling effects but incurring a trade-off in silicon area efficiency.

In a typical wireline system, particularly in scenarios involving Serializer/Deserializer (SERDES) applications, utilizing multiple Voltage-Controlled Oscillators (VCOs) is commonplace. This phenomenon can be attributed to two key factors:
I. Diverse Frequency Band Requirements: In certain instances, diverse frequency bands are mandated for different functionalities. For instance, USB 3.0 mandates a 6 GHz clock, while HDMI necessitates 3.2 GHZ. This disparity in frequency bands naturally prompts the employment of distinct VCOs and their corresponding inductors.

II. Optimizing VCO Gain: An additional motivation arises from optimizing VCO gain (K_{vco}). Attempting to encompass all frequency bands within a single VCO might lead to an unfeasibly high K_{vco}. To circumvent this, the alternative to multiple VCOs becomes crucial, allowing for the minimization of K_{vco}. However, within this multi-VCO framework, a challenge surfaces due to the spatial proximity of inductors. Magnetic flux emanating from one inductor can inadvertently couple with neighboring inductors, inducing transformer-like behaviour. This effect can worsen scenarios involving three coils, presenting similar challenges with the added complexity of a three-coil transformer. The consequences of this coupling can be detrimental. The RF signal emanating from one coil can influence adjacent signals, manifesting as unwanted Frequency Modulation (FM) and inducing worsened phase noise in the second VCO. In extreme cases, the frequency of the second VCO might shift away from its intended nominal operating frequency, introducing functionality failure. The coexistence of closely situated inductors within this multi-VCO framework necessitates strategic solutions to mitigate these coupling effects and their potential detrimental impacts on overall system performance.

The prevailing issue with conventional spiral/octagonal inductors is mutual coupling between on-chip coil pairs. This mutual inductance escalates notably with the spacing between the inductors. However, adjusting the radius is not viable as it controls the inductance, a critical factor for specific tasks. This difficulty can lead to elevated clock jitter or VCO pulling. To overcome this problem, several methodologies have been presented to resolve the issue by using high resistance substrate, increasing the spacing between coils, incorporating extensive ground shielding, or introducing bumps can terminate flux on low-impedance nodes and coils can be positioned orthogonally to minimize mutual coupling.

Traditional 8-shaped inductors (US20210280349A1) effectively counter a magnetic flux within a symmetrical area. Its operation is like upon entering terminal P, a positive signal generates a positive magnetic flux. As the signal incidents into the upper lobe, it generates a negative magnetic flux resulting in the mutual cancellation of the magnetic field along the horizontal axis. In essence, the challenge of mutual coupling necessitates innovative solutions to avert adverse impacts on performance and operation. Despite its improved performance compared to conventional counterparts, the effectiveness of this inductor's flux cancellation is confined to the symmetric axis. However, neighboring coils may be positioned anywhere in chip implementations, rendering such cancellation ineffective. Additionally, the 8-shaped inductor's implementation on the chip poses challenges as the crossing metal degrades the quality factor. While a possible resolution could involve using off-chip inductors, this introduces the need for extra bumps or pads to be added to the chip. However, this solution could elevate the area requirement and cost of the Printed Circuit Board (PCB), which could be better. In contrast, the present proposal offers a solution that improves the coupling without increasing the silicon area cost or PCB manufacturing expenses.

Hence to overcome the aforesaid drawbacks an efficient broken ground ring-assisted multi-lobe inductor structure is required for natural flux cancellation, effectively conserving silicon area while still achieving the desired mitigation of coupling-related challenges.

### OBJECTS OF THE INVENTION

Main object of the present disclosure is to provide a multi-lobe inductor structure to provide the multi-lobe inductor structure encapsulated between a ground ring and a broken ground ring fabricated at the substrate to utilize a high-resistance substrate to avoid potentially encountering Latch-up problems.

Another object of the present disclosure is to provide an architecture of the electronic device, which prevents flux from reaching neighboring coils, thus mitigating coupling effects and minimize or improved mutual coupling. without increasing the silicon area cost or PCB manufacturing expenses.

Yet another object of the present disclosure is to provide the multi-lobe inductor structure to provide an effective on-chip technique, where the surrounded ground ring and the broken ring around the inductor serves as a magnetic barrier and effectively terminates all flux propagation.

### SUMMARY OF THE INVENTION

Before the present system is described, it is to be understood that this application is not limited to the particular machine, device or system, as there can be multiple possible embodiments that are not expressly illustrated in the present disclosures. It is also to be understood that the terminology used in the description is for the purpose of describing the particular versions or embodiments only, and is not intended to limit the scope of the present application. This summary is provided to introduce aspects related to a multi-lobe inductor structure, and the aspects are further elaborated below in the detailed description. This summary is not intended to identify essential features of the proposed subject matter nor is it intended for use in determining or limiting the scope of the proposed subject matter.

In an embodiment, the present invention discloses an electronic device comprising a multi-lobe differential inductor has two terminals fabricated on a P-substrate, wherein the inductor comprises side-lobes (L₁, L₃) coupled with a main coil on the first side and a second side, a ground ring (M₅) positioned at a predetermined distance around the inductor on the substrate and electrically connected to a grounded polarity, a broken ring electrically coupled with the ground ring, positioned around a perimeter of the substrate such that the inductor is surrounded by the ground ring and the broken ring, wherein the broken ring defines a plurality of parallelly arranged structures, each structure comprises a plurality of metal segments (M₁-M₄, M₆-M₁₀) parallel to and separated by a predetermined distance from each other, and electrically connected to and perpendicular to the ground ring.

In another embodiment, the present invention provides the side lobes configured to generate an electromagnetic flux in opposite direction of an electromagnetic flux generated by the main coil.

In another embodiment, the present disclosure provides a width of the side lobes and the main coil are equal, and wherein a length of a coil of the side lobes can vary with respect to a length of the main coil.

In another embodiment, the present disclosure provides that each metal segment has a predetermined width and each metal segment are separated with each other at a predetermined distance, provided the predetermined width and the predetermined distance is a technology-dependent parameter.

In yet another embodiment, the present disclosure provides that the broken ring is electrically coupled with the ground ring via interconnects.

In another embodiment, the present disclosure provides that the ground ring has a top and a bottom surface, where both the top and bottom surface is electrically coupled with the broken ring.

In yet another embodiment, the present disclosure provides the ground ring placed around the inductor at the predetermined dimensions, provided the predetermined dimensions are a technology-dependent parameter.

In another embodiment, the present disclosure provides that the broken ring when coupled with the ground ring configured to generate the opposite electromagnetic flux which cancels an electromagnetic flux generated by the inductor.

In another embodiment, the present disclosure provides that the broken ring and the ground ring are implemented on different metal layers of the substrate.

In another embodiment, the present disclosure provides a method for fabrication of electronic device comprising, depositing a multi-lobe differential inductor having two terminals on a P-substrate, wherein the inductor comprises side-lobes (L₁, L₃) coupled with a main coil (L₂) on a first side and a second side; positioning a ground ring (M₅) around the inductor at a predetermined distance on the substrate and configuring the ground ring with a grounded polarity; coupling a broken ring with the ground ring (M₅) while positioning the broken ring around a perimeter of the substrate such that the inductor is surrounded between the ground ring and the broken ring; wherein the broken ring defines a plurality of parallelly arranged structures, each structure comprises a plurality of metal segments (M₁-M₄, M₆-M₁₀) parallel to and separated by a predetermined distance from each other and electrically connected to and perpendicular to the ground ring.

### BRIEF DESCRIPTION OF DRAWINGS

The foregoing summary, as well as the following detailed description of embodiments, is better understood when read in conjunction with the appended drawings. For the purpose of illustrating the disclosure, there is shown in the present document example constructions of the disclosure, however, the disclosure is not limited to the specific methods and device disclosed in the document and the drawing. The detailed description is described with reference to the following accompanying figures.

FIG. 1: illustrates a top view of a multi-lobe inductor surrounded by a ground ring and a broken ring, in accordance with an embodiment of the present subject matter.

FIG. 2: illustrates a 3 dimensional (3D) view of a multi-lobe inductor placed on the substrate and surrounded by the ground ring and broken ring by using multiple metal layers, in accordance with an embodiment of the present subject matter.

FIG. 3: illustrates a coupling of a broken ring with the ground ring;

FIG. 4: illustrates an experimental setup for a coupling.

FIG. 5: illustrates a graph indicating a coupling vs distance measurement and effect for the proposed invention.

The figures depict various embodiments of the present disclosure for purposes of illustration only. One skilled in the art will readily recognize from the following discussion that alternative embodiments of the structures illustrated herein may be employed without departing from the principles of the disclosure described herein.

### DETAILED DESCRIPTION

Some embodiments of this disclosure, illustrating all its features, will now be discussed in detail. The words “comprising”, “having”, and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any devices and methods similar or equivalent to those described herein can be used in the practice or testing of embodiments of the present disclosure, the exemplary, devices and methods are now described. The disclosed embodiments are merely exemplary of the disclosure, which may be embodied in various forms.

Various modifications to the embodiment will be readily apparent to those skilled in the art and the generic principles herein may be applied to other embodiments. However, one of ordinary skill in the art will readily recognize that the present disclosure is not intended to be limited to the embodiments illustrated, but is to be accorded the widest scope consistent with the principles and features described herein.

Following is a list of elements and reference numerals used to explain various embodiments of the present subject matter.

| Reference Numeral | Element Description |
|---|---|
| 100 | Multi-lobe differential inductor |
| 101 | Ground ring |
| 102 | Broken ring |
| 103 | Side lobes (L1, L3) |
| 104 | Main coil (L2) |
| 107 | Two terminals (P and N) |
| 201 | Substrate |
| 202 | Metal segments (M₁-M₄, M₆-M₁₀) |

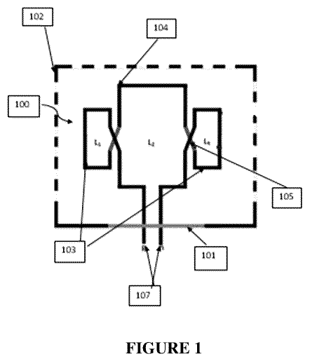

FIG. 1 illustrates a top view of the electronic device. The present invention discloses an electronic device. The electronic device comprises a multi-lobe differential inductor having two terminals fabricated on a P-substrate, wherein the inductor comprises side-lobes (L₁, L₃) coupled with a main coil (L₂), where the side lobe L₁ is coupled with the main lobe on a first side (left hand side) and the side lobe L₂ is coupled with the main lobe on a second side (right hand side). The sides lobes may or may not identical in dimensions. However, preferably in present invention, the width of the side lobes (L₁, L₃) and the main coil (L₂) are maintained as equal, and the length of a coil of the side lobes can vary with respect to the length of the main coil. The side lobes (L₁, L₃) serve as side cancellation lobes, while main coil (L₂) is the primary lobe contributing the bulk of inductance. When a positive signal is introduced at terminal P, a signal current flows from the bottom to the top. This signal travels upwards in Lobe L₁ through the cross-connections, and the same phenomenon is replicated in Lobe L₃. Crucially, the signal directions in the primary and side lobes are perpetually opposing. Consequently, the flux generated is systematically nullified in all directions. The side lobes (L₁, L₂) and main coil (L₃) maintain wider space amongst them to avoid coupling effects. The L₂ has a wider area than L₁ and L₃. The width of a metal line used for the side lobes and the main coil is the same for the inductor. The side lobes are connected with the main lobes either via a coupling metals or may be made as a continuous metal line arranged as shown in said figure. The electronic device also has a broken ring, and the ground ring. Both said rings surround the multi-lobe differential inductor and both the ring improves the isolation performance of the electronic device. This design innovation is advantageous, as it significantly mitigates flux leakage in all directions beyond the symmetric line. The broken ring and the ground ring may act like a transformer, which means the grounded ring is a primary coil and the other a secondary coil i.e. broken grounded ring. So when flux leakage happens forms the aggressor circuit. This broken ring creates a negative current, which induces the opposite polarity flux (because the broken ring is connected to P-sub) and chances the original flux coming from the inductor.

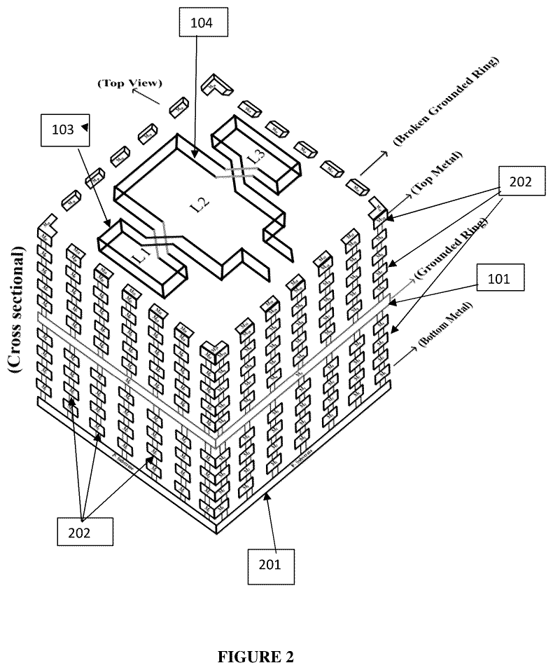

FIG. 2 illustrates the exploded view of the electronic device. The electronic device comprises multi-lobe differential inductor having two terminals fabricated on a P-substrate, wherein the inductor comprises side-lobes L₁ and L₃ coupled with a main coil (L₂) on a first side (right hand side) and a second side (left hand side), respectively. The ground ring (M₅) is positioned at a predetermined distance around the inductor on the substrate and electrically connected to a grounded polarity. The ground ring is coupled with the broken ring which is positioned around a perimeter of the substrate such that the inductor is surrounded by the ground ring and the broken ring.

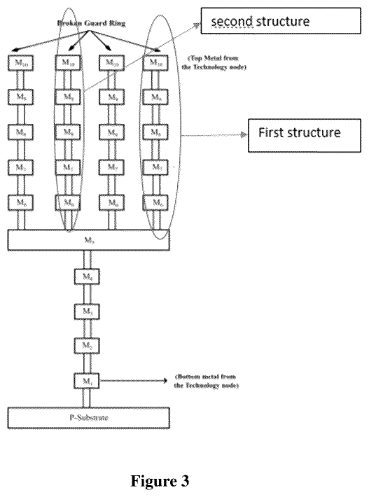

The broken ring appears to be an arrangement of plurality of parallelly arranged structures as indicated in FIG. 3. The structure comprises a plurality of metal segments (M₁-M₄, M₆-M₁₀) parallel to and separated by a predetermined or known distance from each other, and electrically connected to and perpendicular to the ground ring. The metal segments (M₁-M₄, M₆-M₁₀) are disposed on the substrate 100, and each said metal segment is electrically connected to the ground ring, wherein each metal segment is paced at a distance from each other. For clarity, the structures are defined in the FIG. 3. The first structure comprises multiple metal segments parallel to each other. The metal segments are disposed on the substrate 100 and electrically connected to the ground ring. The second structure comprises multiple metal segments parallel to each other. The metal segments are disposed on the substrate 100 and electrically connected to the ground ring. The metal segments are arranged around the perimeter of the substrate. It is not necessary that the broken ring comprises a plurality of metal segments in the plurality of structures. For example, the first structure may comprise a single metal segment, and the second structure may comprise a single metal segment, where the metal segment from the first structure is parallel to the metal segment of the second structure, and the metal segment of the first and second structures lies on a single plane, around the perimeter of the substrate, and where each metal segment is coupled with the ground ring.

The broken ring has been implemented as a primary inductor, but it has been moved to another layer of the substrate to avoid the routing congestion for the main inductor terminals p, n. The broken ring and the ground ring are implemented on different metal layers of the substrate. Therefore, the multi-lobe architecture reduces coupling and improves the Quality factor (Q) of the inductor. The broken ring and the ground ring are connected via interconnect.

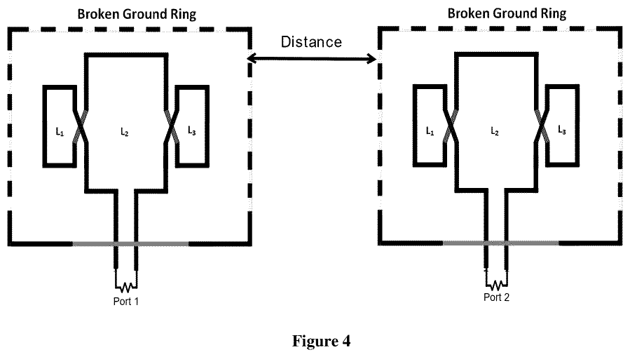

To assess the efficacy of the present electronic device, an adjacent inductor was placed for simulation purposes, and S-parameters were analyzed, explicitly focusing on S21. FIG. 4 represents the experimental setup, with Port-1 linked to the aggressor circuit and Port-2 associated with the victim. Crosstalk is noise induced by one signal (aggressor) that interferes with another signal (victim). The grounded ring and the broken grounded ring surround the inductor. It is not connected to the positive or negative terminals. As indicated in FIG. 4, flux leakage happens forms the aggressor circuit. This broken ring creates a negative current, which induces the opposite polarity flux (because the broken ring is connected to P-sub), and chances the original flux change comes from the inductor.

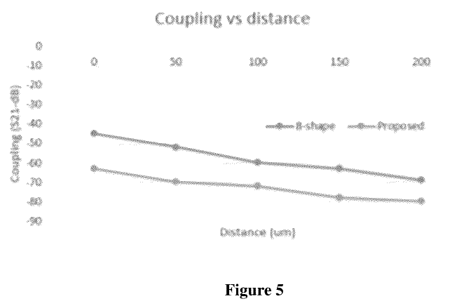

The resulting S21 in dB, showcased in FIG. 5, illustrates intriguing insights. Notably, coupling consistently improves for conventional and inductors with increasing distance between the coils. However, the proposed coil outperforms its counterparts in coupling strength, boasting a remarkable 15 dB enhancement at a distance of 50 um. As shown in FIG. 5, different distances separate two inductors, and the mutual coupling of each distance is reviewed. Notably, coupling consistently improved, and there is a better improvement in the 50 um separation of the two inductors. FIG. 5 is about the mutual coupling and is unrelated to the Q factor. The multi-lobe inductor layout surrounded by the ground ring and the broken ring increases the area efficiency for on-chip implementation and improves the coupling coefficient to the neighbouring inductors. Further, multi-lobe inductor layout surrounded by the ground ring and the broken ring improves the VCO pulling effect due to the transmitter power amplifier. The VCO operates at the desired frequency. If the VCO is shifted or pulled from the desired frequency because of external ambiance, like a transmitter as a power amplifier. The effect is said to be a pulling effect. Because of this effect, there is a mismatch in impedance by the load of the VCO. In general, there are high losses due to the inductor. So, using a multi-lobe inductor with a broken and grounded ring improves the coupling from the neighbouring inductors from the other architectures, such as VCO and power amplifier. So that there is an impedance matching by the load of the VCO, and it improves the VCO pulling effect due to the transmitter power amplifier.

The subject matter enable to provide the multi-lobe inductor structure to provide cumulative flux linkage and enhanced inductance, reduce coupling, and improve quality factor Q and isolation between adjacent inductors.

Further, the subject matter enable to provision of the multi-lobe inductor structure to minimize mutual coupling and enable to provide the multi-lobe inductor structure to mitigate flux leakage in all directions beyond the symmetric line.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present.

Although implementations for the multi-lobe inductor structure have been described in language specific to structural features and/or methods, it is to be understood that the appended claims are not necessarily limited to the specific features described. Rather, the specific features are disclosed as examples of implementation for the multi-lobe inductor structure.

1. An electronic device comprising:
a multi-lobe differential inductor having two terminals fabricated on a substrate, wherein the inductor comprises side-lobes (L₁, L₃) coupled with a main coil (L₂) on a first side and a second side;
a ground ring (M₅) positioned at a predetermined distance around the inductor on the substrate and electrically connected to a grounded polarity;
a broken ring electrically coupled with the ground ring (M₅), positioned around a perimeter of the substrate such that the inductor is surrounded by the ground ring and the broken ring;
wherein the broken ring defines a plurality of parallelly arranged structures, each structure comprises a plurality of metal segments (M₁-M₄, M₆-M₁₀) parallel to and separated by a predetermined distance from each other, and electrically connected to and perpendicular to the ground ring.

2. The electronic device as claimed in claim 1, wherein the side lobes are configured to generate an electromagnetic flux in opposite direction of an electromagnetic flux generated by the main coil.

3. The electronic device as claimed in claim 1, wherein a width of the side lobes and the main coil are equal, and wherein a length of a coil of the side lobes can vary with respect to a length of the main coil.

4. The electronic device as claimed in claim 1, wherein each metal segment has a predetermined width and each metal segment is separated with each other at a predetermined distance, provided the predetermined width and the predetermined distance is a technology-dependent parameter.

5. The electronic device as claimed in claim 1, wherein the broken ring is electrically coupled with the ground ring via interconnects.

6. The electronic device as claimed in claim 1, wherein the ground ring has a top and a bottom surface, where both the top and bottom surface is electrically coupled with the broken ring.

7. The electronic device as claimed in claim 1, wherein the ground ring is placed around the inductor at the predetermined dimensions, provided the predetermined dimensions are a technology-dependent parameter.

8. The electronic device as claimed in claim 1, wherein the broken ring when coupled with the ground ring configured to generate the opposite electromagnetic flux which cancels an electromagnetic flux generated by the inductor.

9. The electronic device as claimed in claim 1, wherein the broken ring and the ground ring are implemented on different metal layers of the substrate.

10. A method for fabrication of electronic device comprising,
depositing a multi-lobe differential inductor having two terminals on a P-substrate, wherein the inductor comprises side-lobes (L₁, L₃) coupled with a main coil (L₂) on a first side and a second side;
positioning a ground ring (M₅) around the inductor at a predetermined distance on the substrate and configuring the ground ring with a grounded polarity;
coupling a broken ring with the ground ring (M₅) while positioning the broken ring around a perimeter of the substrate such that the inductor is surrounded between the ground ring and the broken ring;
wherein the broken ring defines a plurality of parallelly arranged structures, each structure comprises a plurality of metal segments (M₁-M₄, M₆-M₁₀) parallel to and separated by a predetermined distance from each other and electrically connected to and perpendicular to the ground ring.
